(19) United States
(12) Patent Application Publication
(10) Pub. No.: US 2025/0049081 A1
(43) Pub. Date: Feb. 13, 2025

(54) BEVERAGE ADDITIVES COMPRISING A CLOUDING AGENT

(71) Applicant: FIRMENICH SA, Satigny (CH)

(72) Inventors: Hui Ling GUO, Shanghai (CN); Ding KANG, Shanghai (CN); Yongtao WU, Shanghai (CN); Ronald SKIFF, Plainsboro, NJ (US)

(73) Assignee: FIRMENICH SA, Satigny (CH)

(21) Appl. No.: 18/721,300

(22) PCT Filed: Dec. 19, 2022
(86) PCT No.: PCT/EP2022/086534

§ 371 Date: Jun. 18, 2024

(30) Foreign Application Priority Data
Dec. 21, 2021 (WO) PCT/CN2021/139959
Jan. 27, 2022 (EP) 22153610.5

(51) Int. Cl. A23L 2/62; A23L 19/00; A23L 33/21; C12C 5/02

(52) U.S. Cl. CPC A23L 2/62; A23L 19/01; A23L 33/21; C12C 5/02

(57) ABSTRACT

The present invention relates to a beverage additive comprising a clouding agent comprising a soluble citrus fiber as well as to a beverage comprising said beverage additive. The present invention further relates to a method for the preparation of soluble citrus fibers and the use of said soluble citrus fibers as a clouding agent in a beverage.

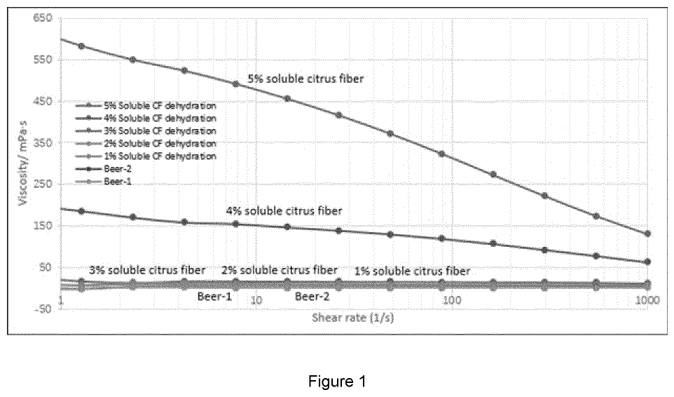

### TECHNICAL FIELD

The present invention relates to a beverage additive comprising a clouding agent comprising a soluble citrus fiber as well as to a beverage comprising said beverage additive. The present invention further relates to a method for the preparation of soluble citrus fibers and the use of said soluble citrus fibers as a clouding agent in a beverage.

### BACKGROUND OF THE INVENTION

Clouding agents play an important role as food additive and are applied in beverages such as fruit juices or fruit-flavored beverages to impart inter alia turbidity and, thus, to achieve a more natural-looking and visually appealing beverage similar to fresh juice.

The food industry has traditionally used brominated vegetable oil and titanium dioxide as clouding agents. However, the use of brominated vegetable oil has been regulatory restricted and in some regions, e.g. in the European Union, completely banned from use as a food additive. Recently, the use of titanium dioxide has been banned as a clouding agent in beverages in many countries due to its potential health risks. Similarly, gum arabic that finds application in alcoholic beverages as a clouding agent is under regulatory pressure, as its use is e.g. not allowed in beer in the European Union.

The food industry has also used fat-based emulsions as clouding agents. However, clouding agents based on fat develops an off taste, such as an undesirable rancid note due to the hydrolysis of the fat. Moreover, the presence of fat leads to further disadvantages such as clumping of the mixture or significantly decreased solubility of the mixture when reconstituted in water. A reduction of fat in turn reduces the fat intake by the consumers and can lead to prevention of the risk of obesity and diseases, which is associated with obesity, such as heart diseases and diabetes and specific types of cancer.

In view of the above, there is a need to provide beverage additives comprising clouding agents for use in beverages that can impart stable turbidity in liquids, in particular in acidic and alcoholic beverages. Moreover, there is a need to provide beverage additives comprising clouding agents without imparting a strong off taste or any deleterious effect on the flavor of the beverage. In particular, natural clouding agents are highly desired by consumers.

The present invention addresses these needs. In particular, the present invention provides beverage additives comprising clouding agents, which are natural and perform at least the same or even better than previously used clouding agents.

### BRIEF DESCRIPTION OF THE FIGURE

The FIGURE shows the viscosity [mPa·s] of different aqueous citrus fiber dispersions at various shear rates at a measurement temperature of 25° C. Further, the viscosity of two commercial beer samples is shown.

### SUMMARY OF THE INVENTION

According to a first aspect, the present invention relates to a beverage additive comprising a clouding agent comprising a soluble citrus fiber, and optionally, one or more beverage ingredients.

In a second aspect, the present invention relates to a beverage comprising the beverage additive according to the invention and a beverage base.

In a third aspect, the present invention relates to the use of a soluble citrus fiber as a clouding agent in a beverage.

In a fourth aspect, the present invention relates to a method of increasing the turbidity of a beverage comprising the step of adding a soluble citrus fiber to a beverage.

In a fifth aspect, the present invention relates to a method for preparing soluble citrus fibers comprising the steps of:
a) Dispersing a mixture of soluble and insoluble citrus fibers in water;
b) Subjecting the dispersion obtained in step a) to a centrifugation step, wherein a relative centrifugal force (RCF) of at least 1500×g is applied;
c) Collecting the supernatant comprising soluble citrus fibers;
d) Optionally, subjecting the supernatant to a concentration step and/or to a drying step.

### DETAILED DESCRIPTION OF THE INVENTION

In a first aspect, the invention relates to a beverage additive comprising a clouding agent comprising a soluble citrus fiber, and optionally, one or more beverage ingredients.

By “beverage additive” is understood a composition, which is used in or applied to liquids resulting in a beverage, i.e. resulting in a drinkable liquid.

In a particular embodiment, the beverage additive is in powdered form or in the form of a liquid concentrate.

In a particular embodiment, the beverage additive is in powdered, granulated, or tablet form.

The beverage additive in powdered or granulated form can be prepared by several drying methods. In an embodiment, the beverage additive is prepared by spray drying. In another embodiment, the beverage additive is prepared by crystallization or a freeze-drying.

In a particular embodiment, the beverage additive may be provided in a liquid form. The beverage additive might be a concentrated liquid. Concentrated liquids might be selected from the group consisting of syrups, such as fountain syrups, squashes or cordials. The beverage additive might be a suspension.

According to the present invention, the beverage additive comprises a clouding agent.

By “clouding agent” an agent is understood, which imparts turbidity in a liquid or increases the turbidity in a slightly turbid or turbid liquid.

“Turbidity” in turn is described as the opaqueness of a liquid due to the presence of suspended solids or due to an emulsion and is measured in terms of nephelometric turbidity units (NTU). Methods of measuring turbidity are known in the art. Most turbidity monitors are based on the nephelometric method, which measures the amount of light scattered at right angles to an incident light beam by particles present in a sample. Measured values are indicated in nephelometric turbidity units, NTU. The basic instrument incorporates a single light source and a photodetector to sense the scattered light. Internal lenses and apertures focus the light onto the sample, while the photodetector is set at 90 degrees to the direction of the incident light to monitor scattered light. Other methods of measuring turbidity might be analyzation of liquids by using UV-visible spectrophotometer at a particular wavelength and by using turbidity-meter.

In the present invention, the turbidity values were measured using a Hach 2100N IS Laboratory Turbidimeter equipped with a LED light source (860±30 nm). Measurement range: 0-1000 NTU. Resolution: 0.001 NTU. The inside and outside of the sample cell were thoroughly cleaned and dried and then the solution was loaded to the cell near the top (˜30 mL). Each sample must be a uniform solution without bubbles or precipitates in the sample cell. The measured NTUs were average values of three replicates.

According to the invention, the clouding agent comprises a soluble citrus fiber.

Under a soluble citrus fiber, a citrus fiber is understood that is soluble in water. By contrast, an insoluble citrus fiber does not dissolve in water. In a particular embodiment, the soluble citrus fiber has a solubility of up to 8 g/100 ml, based on its solubility in water at 20° C. Preferably, the soluble citrus fiber has a solubility of between 1 to 8 g/100 ml, more preferably between 2 to 8 g/100 ml, even more preferably between 3 to 8 g/100 ml, yet more preferably between 4 to 8 g/100 ml, and most preferably between 5 to 8 g/100 ml.

In a particular embodiment, the soluble citrus fiber is a natural soluble citrus fiber. The term “natural” refers to the fact that the soluble citrus fiber is obtained from a natural product. The soluble citrus fiber is still considered “natural” when it has been treated with acids or bases. However, the soluble citrus fiber is not considered natural anymore when it has been chemically modified, for example by means of derivatisations, such as halogenations, acetylations, esterifications, alkylations, silylations, cyclizations, or carboxylations.

In a particular embodiment, the soluble citrus fiber is obtained from orange, lemon, lime, or any mixture thereof. Preferably, the soluble citrus fiber is obtained from orange.

In a particular embodiment, the soluble citrus fiber has not been extruded. In particular, the citrus fiber has not been extruded to become soluble.

In a particular embodiment, the clouding agent consists of soluble citrus fiber.

In a particular embodiment, the clouding agent does not comprise an insoluble citrus fiber. As indicated above, a citrus fiber is considered insoluble when it does not dissolve in water. Preferably, it does not dissolve in water at 20° C.

In a particular embodiment, the clouding agent is a natural clouding agent. The term “natural clouding agent” refers to a clouding agent that has been isolated from a natural product, such as a plant, a part of a plant, an animal or a part of an animal. In other words, the components comprised in the clouding agent are of natural origin and have been isolated from natural products. When the clouding agent and the components comprised in the clouding agent, respectively, have been treated with acids or bases, the clouding agent is still considered as a natural clouding agent. However, in case the clouding agent and the components comprised in the clouding agent, respectively, have been chemically modified, for example by means of derivatisations, such as for example halogenations, acetylations, esterifications, alkylations, silylations, cyclizations or carboxylations, the clouding agent is no longer considered a natural clouding agent.

In a particular embodiment, the clouding agent further comprises coacervate hydrocolloid particles comprising a protein and a polysaccharide.

Coacervation is a phenomenon that produces coacervate colloidal droplets, wherein two liquid phases will co-exist: a dense, polymer-rich phase and a very dilute, polymer-deficient phase. By “coacervate hydrocolloid particle” is meant an organic-rich droplet formed via liquid-liquid phase separation. The phase separation is resulting from association of oppositely charged molecules, i.e. oppositely charged polyelectrolytes such as polysaccharides and proteins. Polysaccharides such as gum arabic or alginate might be understood as negatively charged polyelectrolytes. Proteins can be understood as positively charged polyelectrolytes.

The use of coacervate hydrocolloid particles as clouding agent is advantageous, since such coacervate hydrocolloid particles are stable in acidic as well as in neutral liquids, and are therefore applicable in both. In contrast thereto, clouding agents comprising aggregated proteins are typically not stable in a neutral environment.

In an embodiment, the beverage additive comprises coacervate hydrocolloid particles, wherein the protein of the coacervate hydrocolloid particles is selected from the group consisting of rice protein, pea protein, mung bean protein, whey protein and any combination thereof. Preferably, the protein of the coacervate hydrocolloid particles is whey protein.

In an embodiment, the beverage additive comprises coacervate hydrocolloid particles, wherein the polysaccharide of the coacervate hydrocolloid particles is selected from the group consisting of pectin, carboxymethylcellulose, alginate, xanthan gum, gellan gum, gum arabic and any combination thereof. Preferably, the polysaccharide of the coacervate hydrocolloid particles is gum arabic.

In an embodiment, the beverage additive comprises coacervate hydrocolloid particles, wherein the size of the coacervate hydrocolloid particles is from 0.5 to 5 μm, more preferably from 0.7 to 3 μm, still more preferably from 1 to 2 μm. The particle size can be measured, for example, with a Mastersizer 3000 (Malvern Instruments, Worcestershire, UK).

In an embodiment, the weight ratio of the protein to the polysaccharide in the coacervate hydrocolloid particles is from about 10:1 to 1:10, 3:1 to 1:8, 2:1 to 1:7, preferably 1:1 to 1:6, more preferably 1:2 to 1:5. In a particular embodiment, the weight ratio of the protein to the polysaccharide in the coacervate hydrocolloid particles is about 1:1, about 1:2, about 1:3, about 1:4, about 1:5, more preferably about 1:3.

In an embodiment, the coacervate hydrocolloid particles comprise as a polysaccharide gum arabic and as a protein whey protein. The combination of this polysaccharide and protein is advantageous, since this coacervate hydrocolloid particles provides high stability of the particles in neutral and acidic liquids. Moreover, the turbidity in neutral and acidic beverages is improved. In particular, the proteins primarily provide turbidity by denaturation and aggregation of proteins. The polysaccharides are used as stabilizers to provide long-term stability of hydrocolloid particles. Furthermore, such a combination does not impart a deleterious flavor to the beverage.

In a particular embodiment, the clouding agent further comprises a regenerated insoluble dietary fiber.

Under a regenerated dietary fiber, a dietary fiber is understood whose original fiber structure has not been altered but that shows decreased crystallinity after regeneration. Decreased crystallinity can be determined e.g. by means of microscopy, X-ray diffraction measurement, or by Fourier transform infrared spectroscopy analysis.

In an embodiment, the regenerated insoluble dietary fiber is selected from the group consisting of lignin, cellulose, hemicellulose, chitin and any combination thereof. The regenerated insoluble dietary fiber is preferably chitin.

Chitin is the most common polysaccharide in nature besides cellulose and is used for structure formation. It differs from cellulose by an acetamide group and is a natural fiber, which is found in fungi as well as in articulata and molluscs. Regenerated chitin can be obtained by an acidic washing process, wherein a more natural clouding agent as modified starches, brominated vegetable oils or titanium dioxide can be achieved. Such regenerated chitin is suitable for food applications, since it is not toxic.

In an embodiment, the regenerated insoluble dietary fiber is purified chitin. Purified chitin can be obtained by washing crude chitin powder, wherein the crude chitin powder is subjected to an alkali washing and acid washing processes. The resulting chitin residue can be washed to obtain purified chitin.

In an embodiment, the regenerated insoluble dietary fiber is regenerated chitin. Regenerated chitin can be obtained by a process, wherein a) the purified chitin is pre-wetted with deionized water, b) phosphoric acid and deionized water is added to the pre-wetted purified chitin and then mixed with phosphoric acid to obtain a homogenous suspension, c) the chitin suspension obtained is incubated in a shaking bath to obtain a clear solution, d) the solution is than diluted with deionized water to obtain a dispersion, e) the dispersion is centrifuged, f) the residue is washed with water to reach a constant pH value and regenerated chitin can be obtained.

The beverage additive according to the invention may optionally comprise one or more beverage ingredients.

By “beverage ingredient” it is meant an ingredient which can be usually used in beverages, such as thickeners, flavors, food colorings, nutrients, acid, acid salts, sweeteners, stabilizers, preservative or a combination thereof.

In an embodiment, the beverage ingredient is a flavor or fragrance. Flavors or fragrances might be any compound, which are typically used in beverages. By the term “flavor” it is herein understood a flavor or flavoring composition being a flavoring ingredient or a mixture of flavoring ingredients, solvents or adjuvants used for the preparation of a flavoring formulation, i.e. a particular mixture of ingredients, which is intended to be added to a drinkable composition to impart, improve or modify its organoleptic properties, in particular its flavor and/or taste. Flavoring ingredients are well known to a person skilled in the art and their nature does not warrant a detailed description here, which in any case would not be exhaustive, the skilled flavorist being able to select them on the basis of his or her general knowledge and according to the intended use or application and the organoleptic effect it is desired to achieve.

The flavoring ingredient may be a taste modifier. A “taste modifier” is understood as an active ingredient that operates on a consumer's taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

By the term “fragrance” it is herein understood a fragrance or fragrance composition being a fragrance ingredient or a mixture of fragrance ingredients, solvents or adjuvants used for the preparation of a fragrance formulation, i.e. a particular mixture of ingredients, which is intended to be added to a perfuming composition. Fragrance ingredients are well known to a person skilled in the art and their nature does not warrant a detailed description here, which in any case would not be exhaustive, the skilled perfumer being able to select them on the basis of his or her general knowledge and according to the intended use or application and the olfactive effect it is desired to achieve. Many of these fragrance and flavoring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, van Nostrand Co., Inc. Solvents and adjuvants of current use for the preparation of a fragrance or flavoring formulation are also well known in the industry.

In an embodiment, the beverage ingredient is a flavor. Typical flavors to be used in the beverage composition according to the present invention are flavors that are derived from or based on fruits where citric acid is the predominant, naturally-occurring acid include but are not limited to, for example, citrus fruits (e.g., lemon, lime), limonene, strawberry, orange, and pineapple. In one embodiment, the flavor is lemon, lime or orange juice extracted directly from the fruit. Further embodiments of the flavor comprise the juice or liquid extracted from oranges, lemons, grapefruits, limes, citrons, clementines, mandarins, tangerines, and any other citrus fruit, or variation or hybrid thereof. In a particular embodiment, the flavor comprises a liquid extracted or distilled from oranges, lemons, grapefruits, limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particularly preferred embodiment, the flavor is lemon or lime. In a further embodiment, the flavor comprises a citrus fruit, preferably lemon. In a particularly preferred embodiment, the flavor is limonene.

In an embodiment, the beverage ingredient is a food coloring. By the term “food coloring” it is herein understood a food coloring composition or a mixture of food coloring ingredients, solvents or adjuvants used for the preparation of a colored formulation, i.e. a particular mixture of ingredients, which is intended to be added to a drinkable composition to impart, improve or modify its optic properties, in particular its color. Food coloring or color additive is any dye, pigment or substance that imparts color when it is added to the beverage. Food coloring is added to make the beverage more attractive, appealing, appetizing or to prevent color loss due to exposure to light, air, temperature extremes, moisture and storage conditions. The food coloring might be natural or synthetic. Coloring ingredients are well known to a person skilled in the art and their nature does not warrant a detailed description here, which in any case would not be exhaustive, the skilled person being able to select them on the basis of his or her general knowledge and according to the intended use or application and the optic effect it is desired to achieve. In an embodiment, the food coloring is one or more food coloring selected from the group consisting of curcumin, carotene, chlorophyll, amaranth, carmine, tartrazine, betanin, and capsanthin.

In an embodiment, the beverage ingredient is a nutrient. Essential nutrients are energy sources, some of the amino acids, a subset of fatty acids, vitamins and certain minerals. In a further embodiment, the beverage ingredient is a mineral or a salt. In another embodiment, the beverage ingredient is a mineral or a salt thereof selected from the group consisting of phosphorus, potassium, magnesium, sodium, calcium, magnesium, iron, zinc or any combination thereof. In another embodiment, the beverage ingredient is a vitamin selected from the group consisting of vitamin A, B, C, D, beta-carotene, riboflavin or any combination thereof. Other vitamins, which can be added to the beverage composition, include vitamin B6, niacin, and vitamin B12. Other suitable vitamins are known by the skilled in the art and can also be used.

In an embodiment, the beverage ingredient is an acid, acid salt or sweetener. According to a particular embodiment, the acid is a food grade acid. According to a preferred embodiment, the acid is selected from the group of citric acid, lactic acid, sorbic acid, phosphoric acid and mixtures thereof. According to a particular embodiment, the acid salt is a food grade acid salt. According to a preferred embodiment, the acid salt is selected from the group of consisting of sodium citrate, sodium lactate, sodium benzoate, sodium sorbate, sodium phosphate, potassium citrate, potassium sorbate, potassium phosphate, calcium phosphate and mixtures thereof. A sweetener according to the present invention relates to natural sweeteners or artificial sweeteners. According to a preferred embodiment, the sweetener according to the present invention relates to natural and artificial sweeteners except of mono- or disaccharides. According to a preferred embodiment, the sweetener is sucrose, maltodextrin, glucose, or fructose. According to a further embodiment, the sweetener is a low-glycemic sweetener. A low-glycemic sweetener has a glycemic index (GI) of 55 or less, preferably of 50 or less. According to a preferred embodiment, the sweetener is selected from the group consisting of stevia extracts, glycosylated derivatives of stevia extracts, sugars, sucralose, D-tryptophan, NHDC, polyols, stevioside, Rebaudioside A, thaumatin, mogrosides, monellin, neotame, aspartame, alitame, potassium acesulfame, saccharine, monoammonium glycyrrhizinate, calcium cyclamate, sodium cyclamate, sodium saccharin, potassium saccharin, ammonium saccharin, and calcium saccharin and mixtures thereof.

In an embodiment, the beverage ingredient is a stabilizer, a preservative or a combination thereof. In another embodiment, the stabilizer is selected from the group consisting of ester gum, sucrose acetate isobutyrate, Neobee oil, sugar alcohol, fructose and mixtures thereof. The preferred stabilizer is ester gum. According to a preferred embodiment, the sugar alcohol is selected from the group consisting of erythritol, isomalt, lactitol, maltitol, mannitol, xylitol and sorbitol and mixtures thereof, preferably erythritol and sorbitol and mixtures thereof, more preferably sorbitol. Preservatives might be any chemical or natural preservatives. Preservatives might be selected from the group consisting of sulfur dioxide, sodium benzoate, tartrazine, benzoic and/or sorbic acid and salts thereof and mixtures thereof. The preferred preservative is sodium benzoate. Further preservatives can also be used and are known by the skilled in the art.

In an embodiment, the weight ratio of clouding agent to beverage ingredient, preferably a flavor, is equal or less than about 0.01:1 to 30:1, preferably 0.1:1 to 10:1.

Another aspect of the invention relates to a beverage comprising the beverage additive according to the invention and a beverage base.

By “beverage base” any suitable liquid is meant. In an embodiment, the beverage base is water, such as table water or mineral water. The beverage base is preferably any juice such as fruit juices and vegetable juices, juice drink, nectar, or smoothie. The beverage base might also be any soft drink such as lemonade or cola or fruit flavored sodas. The beverage base can also be a hot drink or an infusion drink, such as coffee, coffee substitutes, tea, or tea-like drinks, such as iced tea, fruit tea, herbal tea, rooibos, mate tea, lapacho. The beverage base might be mixed drinks, such as cocktails. The beverage base might be milk or yogurt drinks. The beverage base might also be liquors, energy drinks or isotonic drinks. The beverage base might be health drinks, or functional beverages (e.g., nutraceuticals).

By “beverage” any drinkable liquid is meant. In this specification, the term “beverage” is used interchangeable with the term “liquid”. According to an embodiment, the beverage is a nonalcoholic beverage. In a further embodiment, the beverage might be water, such as table water or mineral water. In a preferred embodiment, the beverage might be any juice such as fruit juices and vegetable juices, juice drink, nectar, or smoothie. The beverage might also be any soft drink such as lemonade or cola or fruit flavored sodas. The beverage can also be a hot drink or an infusion drink, such as coffee, coffee substitutes, tea, or tea-like drinks, such as iced tea, fruit tea, herbal tea, rooibos, mate tea, lapacho. The beverage might be mixed drinks, such as cocktails. The beverage might be milk or yogurt drinks. The beverage might also be liquors, energy drinks or isotonic drinks. The beverage might be health drinks, or functional beverages (e.g., nutraceuticals).

In an embodiment, the beverage base is acidic or neutral.

By “acidic” is understood that a liquid or beverage base has a pH value of less than 7.

In a particular embodiment, the beverage has a pH of from 2 to 6, more preferably of from 3 to 4.

By “neutral” is understood that a liquid or beverage base has a pH value of around 7. In an embodiment, the liquid having a pH value between 6 and 8, preferably between 6.5 and 8, and more preferably between 7 and 8, still more preferably between 7 and 7.5.

In a particular embodiment, the beverage is a non-alcoholic or alcoholic beverage. Preferably, the beverage is an alcoholic beverage. Preferably, the alcoholic beverage is beer.

In a particular embodiment, the beverage comprises the clouding agent in an amount of from 0.01 to 5 g/100 ml, preferably from 0.01 to 2 g/100 ml, more preferably from 0.01 to 1 g/100 ml, even more preferably from 0.4 to 0.7 g/100 ml.

In a particular embodiment, the beverage comprises the soluble citrus fiber in an amount of from 0.01 to 5 g/100 ml, preferably from 0.01 to 2 g/100 ml, more preferably from 0.01 to 1 g/100 ml, even more preferably from 0.4 to 0.7 g/100 ml.

In a particular embodiment, the beverage comprises the soluble citrus fiber in a maximum amount of 3 g/100 ml.

In a particular embodiment, the soluble citrus fiber in the beverage has a colloidal particle size of from 0.1 to 10 μm, preferably from 1 to 3 μm. The particle size can be measured, for example, with a Mastersizer 3000 (Malvern Instruments, Worcestershire, UK).

In a particular embodiment, the beverage has a turbidity of from 8 to 500 NTU, preferably of from 120 to 250 NTU.

Another aspect of the present invention relates to the use of a soluble citrus fiber as a clouding agent in a beverage.

In a particular embodiment, the use comprises providing the beverage with a turbidity of from 8 to 500 NTU, preferably of from 120 to 250 NTU.

Another aspect of the present invention relates to a method of increasing the turbidity of a beverage comprising the step of adding a soluble citrus fiber to a beverage.

In a particular embodiment, the method increases the turbidity of the beverage to a turbidity of from 8 to 500 NTU, preferably of from 120 to 250 NTU.

In a particular embodiment, the soluble citrus fiber is added to the beverage at an amount of from 0.01 to 5 g/100 ml, preferably from 0.01 to 2 g/100 ml, more preferably from 0.01 to 1 g/100 ml, even more preferably from 0.4 to 0.7 g/100 ml.

Another aspect of the present invention, relates to a method for preparing soluble citrus fibers comprising the steps of:
a) Dispersing a mixture of soluble and insoluble citrus fibers in water;
b) Subjecting the dispersion obtained in step a) to a centrifugation step, wherein a relative centrifugal force (RCF) of at least 1500×g is applied;
c) Collecting the supernatant comprising soluble citrus fibers;
d) Optionally, subjecting the supernatant to a concentration step and/or to a drying step.

Mixtures of soluble and insoluble citrus fibers can be obtained from citrus peel and/or pulp. The process of preparing such a mixture of soluble and insoluble citrus fibers may comprise treating citrus peel and/or pulp to obtain homogenized citrus peel and/or pulp; washing the homogenized citrus peel and/or pulp with an organic solvent to obtain organic solvent washed citrus peel and/or pulp; drying the organic solvent washed citrus peel and/or pulp; and recovering citrus fiber therefrom.

Such a mixture of soluble and insoluble citrus fibers is dispersed in water in step a) of the method according to the invention.

In a particular embodiment, during step a) the mixture of soluble and insoluble citrus fibers is dispersed in water at a concentration of from 1 to 10% (w/v). Preferably, the mixture of soluble and insoluble citrus fibers is dispersed in water at a concentration of from 2 to 5% (w/v). More preferably, the mixture of soluble and insoluble citrus fibers is dispersed in water at a concentration of from 2 to 4% (w/v). Most preferably, the mixture of soluble and insoluble citrus fibers is dispersed in water at a concentration of 3% (w/v).

During step b), the dispersion obtained in step a) is subjected to a centrifugation step, wherein a relative centrifugal force (RCF) of at least 1500×g is applied.

The relative centrifugal force (RCF) is expressed as times (x) the gravity (g-force or g) and is calculated as follows:

$$RCF = 1.118 \times {10}^{- 5} \times R \times {S}^{2} ,$$

wherein R is the radius of the rotor centrifuge in [cm] and S is the rotor speed in [rpm].

In a particular embodiment, a relative centrifugal force (RCF) is applied during step b) that is at least 2000×g, preferably at least 3000×g, more preferably at least 3500×g, most preferably at least 4000×g.

In a particular embodiment, a relative centrifugal force (RCF) is applied during step b) that is from 1500 to 25000×g, preferably of from 3000 to 20000×g, more preferably of from 3000 to 10000×g, yet more preferably of from 3500 to 4500×g, most preferably of from 3800 to 4200×g.

In a particular embodiment, the rotor of the centrifuge used in step b) has a radius (R) of from 1.5 to 25 cm. Preferably, the rotor has a radius of from 2 to 15 cm. More preferably, the rotor has a radius of from 2.5 to 10 cm. Most preferably, the rotor has a radius of 2.5 cm.

In a particular embodiment, the rotor speed applied during step b) is from 3500 to 15000 rpm. Preferably, the rotor speed is from 11000 to 13000 rpm, more preferably from 11500 to 12500, most preferably the rotor speed is 12000 rpm.

In a particular embodiment, the rotor speed applied during step b) is at least 3500 rpm. Preferably, the rotor speed is at least 5000 rpm. More preferably, the rotor speed is at least 10000 rpm.

In a particular embodiment, the centrifugation is conducted for from 8 to 12 minutes (min). Preferably, the centrifugation is conducted for from 9 to 11 minutes. Most preferably, the centrifugation is conducted for 10 minutes.

In a particular embodiment, centrifuge ST16 (Thermo Scientific) is used during step b). Said centrifuge preferably has a rotor radius (R) of 2.5 cm.

In step c) of the method according to the invention, the supernatant comprising soluble citrus fibers is collected upon the centrifugation step.

Based on the centrifugation conditions described above, soluble citrus fibers accumulate in the supernatant, whereas insoluble citrus fibers will remain in the precipitate. This way, a separation of soluble and insoluble citrus fibers is achieved.

In step d) of the method according to the invention, the supernatant is optionally subjected to a concentration step and/or to a drying step.

Concentration means that part of the water is removed to obtain a higher concentration of soluble citrus fibers in the supernatant. Every suitable method known in the art for concentrating a liquid may be used. The concentrated liquid thus obtained might directly be used as a clouding agent.

A drying step means that the supernatant comprising the soluble citrus fibers is dried to obtain the soluble citrus fibers in powdered form. The powdered soluble citrus fibers thus obtained might directly be used as a clouding agent.

In a particular embodiment, the drying step is performed by means of freeze-drying or spray-drying. Both freeze-drying and spray-drying are well-known drying techniques in the art. For freeze-drying, an ALPHA 1-4 freeze dryer (Christ, Germany) may be used. For spray-drying, a mini-spray dryer (B290, Büchi Labortechnik, Switzerland) may be used.

### EXAMPLES

### Example 1 and Comparative Example 1

### Example 1

30 g of a mixture of soluble and insoluble citrus fibers in powdered form (Citrus fiber 100 M40, Fiberstar, comprising 20 wt. % of soluble citrus fibers, obtained from orange) were dispersed in 1 L of water by stirring overnight. The dispersion thus had a citrus fiber concentration of 3 g/100 ml. The dispersion then has been centrifuged in a ST16 centrifuge (Thermo Scientific; rotor radius of 2.5 cm) at a rotor speed of 12000 rpm for 10 min. The high rotor speed resulted in the accumulation of soluble citrus fibers in the supernatant, but the insoluble citrus fibers remained in the precipitate. Upon centrifugation, the supernatant was collected and concentrated by 10 times. The collected supernatant was then dehydrated using a freezer dryer (ALPHA 1-4, Christ, Germany) at −55° C. for 48 h. Subsequently, the obtained powder was dispersed in Carlsberg Beer (alcohol content of at least 4 vol. %) at a concentration of 0.2 g/100 ml, 0.4 g/100 ml, 0.6 g/100 ml, 0.8 g/100 ml, and 1 g/100 ml followed by pasteurization (60° C., 15 min) before further analysis.

The turbidity evolution (indicated by Nephelometric Turbidity Unit, NTU) with time for the Carlsberg Beer samples containing the freeze dried soluble citrus fiber powders is shown in Table 1 (at 4° C.) and in Table 2 (at 25° C.). As a benchmark, also the turbidity evolution of Kronenbourg Fruity Beer is depicted in said Tables.

TABLE 1
Turbidity evaluation of beer at 4° C.

| | Freeze dried soluble citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 72.6 | 144 | 160 | 289 | 357 | 154 |
| 1 month | 3.3 | 113 | 185 | 203 | 330 | 395 | 186 |
| 2 months | 4.2 | 118 | 191 | 210 | 336 | 403 | 194 |
| 3 months | 4.8 | 125 | 205 | 225 | 345 | 411 | 189 |
| 4 months | 4.5 | 126 | 211 | 212 | 343 | 418 | 191 |

TABLE 2
Turbidity evaluation of beer at 25° C.

| | Freeze dried soluble citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 72.6 | 144 | 160 | 289 | 357 | 154 |
| 1 month | 3.5 | 133 | 203 | 222 | 351 | 421 | 193 |
| 2 months | 3.9 | 149 | 225 | 242 | 369 | 443 | 205 |
| 3 months | 4.6 | 151 | 221 | 248 | 375 | 456 | 214 |
| 4 months | 4.8 | 160 | 228 | 238 | 386 | 451 | 209 |

Tables 1 and 2 demonstrate that a stable turbidity can be achieved with soluble citrus fibers in beer. In particular, Tables 1 and 2 show that over a period of 4 months both at 4° C. and at 25° C., soluble citrus fibers provided the beer with a stable turbidity.

When 0.6% of freeze-dried soluble citrus fiber powders were added to the Carlsberg Beer, a turbidity and stability comparable to the benchmark beer was observed both at 4° C. and 25° C.

### Comparative Example 1

30 g of a mixture of soluble and insoluble citrus fibers in powdered form (Citrus fiber 100 M40, Fiberstar, comprising 20 wt. % of soluble citrus fibers, obtained from orange) were dispersed in 1 L of water by stirring overnight. The dispersion thus had a citrus fiber concentration of 3 g/100 ml. The dispersion then has been centrifuged in a ST16 centrifuge (Thermo Scientific; rotor radius of 2.5 cm) at a rotor speed of 6000 rpm for 10 min. In contrast to Example 1, a significantly lower centrifugation speed was applied in comparative Example 1, which resulted in the accumulation of both soluble and insoluble citrus fibers in the supernatant. Upon centrifugation, the supernatant was collected and concentrated by 10 times. The collected supernatant was then dehydrated using a freezer dryer (ALPHA 1-4, Christ, Germany) at −55° C. for 48 h. Subsequently, the obtained powder was dispersed in Carlsberg Beer (alcohol content of at least 4 vol. %) at a concentration of 0.2 g/100 ml, 0.4 g/100 ml, 0.6 g/100 ml, 0.8 g/100 ml, and 1 g/100 ml followed by pasteurization (60° C., 15 min) before further analysis.

The turbidity evolution (indicated by Nephelometric Turbidity Unit, NTU) with time for the Carlsberg Beer samples containing the freeze-dried citrus fiber powder is shown in Table 3 (at 4° C.) and in Table 4 (at 25° C.). As a benchmark, also the turbidity evolution of Kronenbourg Fruity Beer is depicted in said Tables.

TABLE 3
Turbidity evaluation of beer at 4° C.

| | Freeze dried citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 268 | 337 | 354 | 583 | 664 | 154 |
| 1 month | 3.3 | 216 | 286 | 331 | 526 | 615 | 186 |
| 2 months | 4.2 | 143 | 221 | 252 | 397 | 509 | 194 |
| 3 months | 4.8 | 94 | 154 | 196 | 304 | 418 | 189 |
| 4 months | 4.5 | 75 | 96 | 144 | 253 | 345 | 191 |

TABLE 4
Turbidity evaluation of beer at 4° C.

| | Freeze dried citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 268 | 337 | 354 | 583 | 664 | 154 |
| 1 month | 3.5 | 225 | 294 | 341 | 540 | 632 | 193 |
| 2 months | 3.9 | 156 | 233 | 263 | 405 | 520 | 205 |
| 3 months | 4.6 | 106 | 165 | 204 | 313 | 425 | 214 |
| 4 months | 4.8 | 86 | 103 | 155 | 262 | 357 | 209 |

Tables 3 and 4 indicate that both at 4° C. and at 25° C., the presence of insoluble citrus fibers in the freeze-dried powder results in a decrease of the turbidity over time. Hence, the Carlsberg Beer could not be provided with stable turbidity in the presence of insoluble citrus fibers.

Example 2 and Comparative Example 2

### Example 2

30 g of a mixture of soluble and insoluble citrus fibers in powdered form (Citrus fiber 100 M40, Fiberstar, comprising 20 wt. % of soluble citrus fibers, obtained from orange) were dispersed in 1 L of water by stirring overnight. The dispersion thus had a citrus fiber concentration of 3 g/100 ml. The dispersion then has been centrifuged in a ST16 centrifuge (Thermo Scientific; rotor radius of 2.5 cm) at a rotor speed of 12000 rpm for 10 min. The high rotor speed resulted in the accumulation of soluble citrus fibers in the supernatant, but the insoluble citrus fibers remained in the precipitate. Upon centrifugation, the supernatant was collected and concentrated by 10 times (concentration of soluble citrus fiber in the concentrate was thus 6 g/100 ml). Subsequently, the obtained concentrate was dispersed in Carlsberg Beer (alcohol content of at least 4 vol. %) at a ratio of 1:5, 1:7, 1:9, 1:11, and 1:13 (v/v) followed by pasteurization (60° C., 15 min) before further analysis.

The turbidity evolution (indicated by Nephelometric Turbidity Unit, NTU) with time for the Carlsberg Beer samples containing the soluble citrus fiber concentrate is shown in Table 5 (at 4° C.) and in Table 6 (at 25° C.). As a benchmark, also the turbidity evolution of Kronenbourg Fruity Beer is depicted in said Tables.

TABLE 5
Turbidity evaluation of beer at 4° C.

| | Volume ratio of citrus fiber | | | | | | |
|---|---|---|---|---|---|---|---|
| | dispersion and Carlsberg Beer | | | | | | Kronenbourg |
| Duration | 0 | 1:5 | 1:7 | 1:9 | 1:11 | 1:13 | Fruity Beer |
| 0 | 2.1 | 363 | 295 | 210 | 154 | 149 | 154 |
| 1 month | 3.3 | 408 | 344 | 253 | 195 | 187 | 186 |
| 2 months | 4.2 | 416 | 351 | 264 | 207 | 204 | 194 |
| 3 months | 4.8 | 423 | 367 | 278 | 220 | 215 | 189 |
| 4 months | 4.5 | 435 | 372 | 283 | 226 | 222 | 191 |

TABLE 6
Turbidity evaluation of beer at 25° C.

| | Volume ratio of citrus fiber | | | | | | |
|---|---|---|---|---|---|---|---|
| | dispersion and Carlsberg Beer | | | | | | Kronenbourg |
| Duration | 0 | 1:5 | 1:7 | 1:9 | 1:11 | 1:13 | Fruity Beer |
| 0 | 2.1 | 363 | 295 | 210 | 154 | 149 | 154 |
| 1 month | 3.5 | 426 | 222 | 276 | 207 | 204 | 193 |
| 2 months | 3.9 | 438 | 242 | 283 | 216 | 212 | 205 |
| 3 months | 4.6 | 451 | 248 | 296 | 228 | 225 | 214 |
| 4 months | 4.8 | 460 | 238 | 301 | 236 | 237 | 209 |

Tables 5 and 6 demonstrate that a stable turbidity can be achieved with soluble citrus fibers in beer. In particular, Tables 5 and 6 show that over a period of 4 months both at 4° C. and at 25° C., the soluble citrus fiber concentrate provided the beer with a stable turbidity.

When the Carlsberg Beer is mixed with the soluble citrus fiber concentrate at a ratio of 1:11 and 1:13 (v/v), respectively, a stable turbidity comparable to the benchmark beer has been achieved both at 4° C. and at 25° C., respectively.

### Comparative Example 2

30 g of a mixture of soluble and insoluble citrus fibers in powdered form (Citrus fiber 100 M40, Fiberstar, comprising 20 wt. % of soluble citrus fibers, obtained from orange) were dispersed in 1 L of water by stirring overnight. The dispersion thus had a citrus fiber concentration of 3 g/100 ml. The dispersion then has been centrifuged in a ST16 centrifuge (Thermo Scientific; rotor radius of 2.5 cm) at a rotor speed of 6000 rpm for 10 min. In contrast to Example 2, a significantly lower centrifugation speed was applied in comparative Example 2, which resulted in the accumulation of both soluble and insoluble citrus fibers in the supernatant. Upon centrifugation, the supernatant was collected and concentrated by 10 times. Subsequently, the obtained concentrate was dispersed in Carlsberg Beer (alcohol content of at least 4 vol. %) at a ratio of 1:5, 1:7, 1:9, 1:11, and 1:13 (v/v) followed by pasteurization (60° C., 15 min) before further analysis.

The turbidity evolution (indicated by Nephelometric Turbidity Unit, NTU) with time for the Carlsberg Beer samples containing the citrus fiber concentrate is shown in Table 7 (at 4° C.) and in Table 8 (at 25° C.). As a benchmark, also the turbidity evolution of Kronenbourg Fruity Beer is depicted in said Tables.

TABLE 7
Turbidity evaluation of beer at 4° C.

| | Volume ratio of citrus fiber | | | | | | |
|---|---|---|---|---|---|---|---|
| | dispersion and Carlsberg Beer | | | | | | Kronenbourg |
| Duration | 0 | 1:5 | 1:7 | 1:9 | 1:11 | 1:13 | Fruity Beer |
| 0 | 2.1 | 556 | 503 | 421 | 364 | 345 | 154 |
| 1 month | 3.3 | 498 | 465 | 385 | 314 | 296 | 186 |
| 2 months | 4.2 | 403 | 352 | 273 | 201 | 185 | 194 |
| 3 months | 4.8 | 329 | 286 | 205 | 164 | 121 | 189 |
| 4 months | 4.5 | 264 | 227 | 182 | 225 | 87 | 191 |

TABLE 8
Turbidity evaluation of beer at 25° C.

| | Volume ratio of citrus fiber | | | | | | |
|---|---|---|---|---|---|---|---|
| | dispersion and Carlsberg Beer | | | | | | Kronenbourg |
| Duration | 0 | 1:5 | 1:7 | 1:9 | 1:11 | 1:13 | Fruity Beer |
| 0 | 2.1 | 556 | 503 | 421 | 364 | 345 | 154 |
| 1 month | 3.5 | 512 | 483 | 393 | 326 | 305 | 193 |
| 2 months | 3.9 | 424 | 368 | 286 | 215 | 194 | 205 |
| 3 months | 4.6 | 335 | 297 | 216 | 185 | 136 | 214 |
| 4 months | 4.8 | 273 | 234 | 195 | 233 | 95 | 209 |

Tables 7 and 8 indicate that both at 4° C. and at 25° C., the presence of insoluble citrus fibers in the concentrate results in a decrease of the turbidity over time. Hence, the Carlsberg Beer could not be provided with stable turbidity in the presence of insoluble citrus fibers.

### Example 3 and Comparative Example 3

### Example 3

30 g of a mixture of soluble and insoluble citrus fibers in powdered form (Citrus fiber 100 M40, Fiberstar, comprising 20 wt. % of soluble citrus fibers, obtained from orange) were dispersed in 1 L of water by stirring for 12 hours. The dispersion thus had a citrus fiber concentration of 3 g/100 ml. The dispersion then has been centrifuged in a ST16 centrifuge (Thermo Scientific; rotor radius of 2.5 cm) at a rotor speed of 12000 rpm for 10 min. The high rotor speed resulted in the accumulation of soluble citrus fibers in the supernatant, but the insoluble citrus fibers remained in the precipitate. Upon centrifugation, the supernatant was collected and dehydrated using a mini-spray dryer (B290, Büchi Labortechnik, Switzerland). The inlet and outlet temperatures were set to be 165 and 90° C. with a feed rate of 10 mL/min. Subsequently, the obtained powder was dispersed in Carlsberg Beer (alcohol content of at least 4 vol. %) at a concentration of 0.2 g/100 ml, 0.4 g/100 ml, 0.6 g/100 ml, 0.8 g/100 ml, and 1 g/100 ml followed by pasteurization (60° C., 15 min) before further analysis.

The turbidity evolution (indicated by Nephelometric Turbidity Unit, NTU) with time for the Carlsberg Beer samples containing the spray dried soluble citrus fiber powder is shown in Table 9 (at 4° C.) and in Table 10 (at 25° C.). As a benchmark, also the turbidity evolution of Kronenbourg Fruity Beer is depicted in said Tables.

TABLE 9
Turbidity evaluation of beer at 4° C.

| | Spray dried soluble citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 72 | 135 | 150 | 281 | 350 | 154 |
| 1 month | 3.3 | 112 | 177 | 194 | 323 | 389 | 186 |
| 2 months | 4.2 | 120 | 182 | 206 | 334 | 396 | 194 |
| 3 months | 4.8 | 135 | 191 | 217 | 349 | 407 | 189 |
| 4 months | 4.5 | 143 | 205 | 224 | 353 | 421 | 191 |

TABLE 10
Turbidity evaluation of beer at 25° C.

| | Spray dried soluble citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 72 | 135 | 150 | 281 | 350 | 154 |
| 1 month | 3.5 | 131 | 193 | 312 | 345 | 414 | 193 |
| 2 months | 3.9 | 142 | 202 | 325 | 357 | 425 | 205 |
| 3 months | 4.6 | 155 | 216 | 339 | 364 | 433 | 214 |
| 4 months | 4.8 | 167 | 224 | 346 | 373 | 441 | 209 |

Tables 9 and 10 demonstrate that a stable turbidity can be achieved with soluble citrus fibers in beer. In particular, Tables 9 and 10 show that over a period of 4 months both at 4° C. and at 25° C., soluble citrus fibers provided the beer with a stable turbidity.

When 0.4% of spray-dried soluble citrus fiber powders were added to the Carlsberg Beer, a turbidity and stability comparable to the benchmark beer was observed both at 4° C. and 25° C.

### Comparative Example 3

30 g of a mixture of soluble and insoluble citrus fibers in powdered form (Citrus fiber 100 M40, Fiberstar, comprising 20 wt. % of soluble citrus fibers, obtained from orange) were dispersed in 1 L of water by stirring for 12 hours. The dispersion thus had a citrus fiber concentration of 3 g/100 ml. The dispersion then has been centrifuged in a ST16 centrifuge (Thermo Scientific; rotor radius of 2.5 cm) at a rotor speed of 6000 rpm for 10 min. In contrast to Example 3, a significantly lower centrifugation speed was applied in Comparative Example 3, which resulted in the accumulation of both soluble and insoluble citrus fibers in the supernatant. Upon centrifugation, the supernatant was collected and dehydrated using a mini-spray dryer (B290, Büchi Labortechnik, Switzerland). The inlet and outlet temperatures were set to be 165 and 90° C. with a feed rate of 10 mL/min. Subsequently, the obtained powder was dispersed in Carlsberg Beer (alcohol content of at least 4 vol. %) at a concentration of 0.2 g/100 ml, 0.4 g/100 ml, 0.6 g/100 ml, 0.8 g/100 ml, and 1 g/100 ml followed by pasteurization (60° C., 15 min) before further analysis.

The turbidity evolution (indicated by Nephelometric Turbidity Unit, NTU) with time for the Carlsberg Beer samples containing the spray dried citrus fiber powder is shown in Table 11 (at 4° C.) and in Table 12 (at 25° C.). As a benchmark, also the turbidity evolution of Kronenbourg Fruity Beer is depicted in said Tables.

TABLE 11
Turbidity evaluation of beer at 4° C.

| | Spray dried citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 268 | 337 | 354 | 583 | 664 | 154 |
| 1 month | 3.3 | 216 | 286 | 331 | 526 | 615 | 186 |
| 2 months | 4.2 | 143 | 221 | 252 | 397 | 509 | 194 |
| 3 months | 4.8 | 94 | 154 | 196 | 304 | 418 | 189 |
| 4 months | 4.5 | 75 | 96 | 144 | 253 | 345 | 191 |

TABLE 12
Turbidity evaluation of beer at 25° C.

| | Spray dried citrus fiber | | | | | | |
|---|---|---|---|---|---|---|---|
| | powders in Carlsberg Beer | | | | | | Kronenbourg |
| Duration | 0% | 0.2% | 0.4% | 0.6% | 0.8% | 1% | Fruity Beer |
| 0 | 2.1 | 268 | 337 | 354 | 583 | 664 | 154 |
| 1 month | 3.5 | 225 | 294 | 341 | 540 | 632 | 193 |
| 2 months | 3.9 | 156 | 233 | 263 | 405 | 520 | 205 |
| 3 months | 4.6 | 106 | 165 | 204 | 313 | 425 | 214 |
| 4 months | 4.8 | 86 | 103 | 155 | 262 | 357 | 209 |

Tables 11 and 12 indicate that both at 4° C. and at 25° C., the presence of insoluble citrus fibers in the spray-dried powder results in a decrease of the turbidity over time. Hence, the Carlsberg Beer could not be provided with stable turbidity in the presence of insoluble citrus fibers.

### Example 4

Soluble citrus fibers were prepared as described in Example 1. The freeze-dried soluble citrus fiber powder was then dispersed in deionized water at the amounts indicated in Table 13 (1 g/100 ml, 2 g/100 ml, and 3 g/100 ml) and the evolution of the turbidity over time was recorded. The turbidity over time has been compared to a solution of titanium oxide (0.02 g/100 ml in deionized water).

TABLE 13
Evolution of turbidity with time for freeze-dried soluble
citrus fiber powder and TiO₂ dispersed in deionized water

| | Freeze dried soluble | | | Titanium |
|---|---|---|---|---|
| | citrus fiber powder | | | dioxide (TiO₂) |
| Time | 1% | 2% | 3% | 0.02% |
| 0 | 356 | 692 | 1057 | 1181 |
| 3 h | 354 | 688 | 1052 | 1137 |
| 24 h | 356 | 693 | 1055 | 747 |

Similarly, the freeze-dried soluble citrus fiber powder was dispersed in a citrate buffer solution (pH=3.7) at the amounts indicated in Table 14 (1 g/100 ml, 2 g/100 ml, and 3 g/100 ml) and the evolution of the turbidity over time was recorded. The turbidity over time has been compared to a solution of titanium oxide (0.02 g/100 ml in citrate buffer solution).

TABLE 14
Evolution of turbidity with time for freeze-dried soluble
citrus fiber powder and TiO₂ dispersed in citrate buffer

| | Freeze dried soluble | | | Titanium |
|---|---|---|---|---|
| | citrus fiber powder | | | dioxide (TiO₂) |
| Time | 1% | 2% | 3% | 0.02% |
| 0 | 326 | 672 | 1066 | 1181 |
| 3 h | 323 | 669 | 1063 | 1137 |
| 24 h | 324 | 671 | 1065 | 747 |

From Tables 13 and 14 it can be observed that the freeze-dried soluble citrus fiber provided both the deionized water and the citrate buffer solution with an excellent turbidity that was at least stable for the time measured (24 hours). It can further be observed that by the addition of freeze-dried soluble citrus fibers at an amount of 3 g/100 ml, a turbidity comparable to the titanium dioxide solution could be achieved that was, however, stable over 24 hours as opposed to the titanium dioxide solution.

### Example 5

Soluble citrus fibers were prepared as described in Example 3. The spray-dried soluble citrus fiber powder was then dispersed in deionized water at the amounts indicated in Table 15 (1 g/100 ml, 2 g/100 ml, and 3 g/100 ml) and the evolution of the turbidity over time was recorded. The turbidity over time has been compared to a solution of titanium oxide (0.02 g/100 ml in deionized water).

TABLE 15
Evolution of turbidity with time for spray-dried soluble
citrus fiber powder and TiO₂ dispersed in deionized water

| | Spray dried soluble | | | Titanium |
|---|---|---|---|---|
| | citrus fiber powder | | | dioxide (TiO₂) |
| Time | 1% | 2% | 3% | 0.02% |
| 0 | 361 | 678 | 1078 | 1181 |
| 3 h | 363 | 676 | 1077 | 1137 |
| 24 h | 359 | 674 | 1075 | 747 |

Similarly, the spray-dried soluble citrus fiber powder was dispersed in a citrate buffer solution (pH=3.7) at the amounts indicated in Table 16 (1 g/100 ml, 2 g/100 ml, and 3 g/100 ml) and the evolution of the turbidity over time was recorded. The turbidity over time has been compared to a solution of titanium oxide (0.02 g/100 ml in citrate buffer solution).

TABLE 16
Evolution of turbidity with time for freeze-dried soluble
citrus fiber powder and TiO2 dispersed in citrate buffer

| | Spray dried soluble | | | Titanium |
|---|---|---|---|---|
| | citrus fiber powder | | | dioxide (TiO₂) |
| Time | 1% | 2% | 3% | 0.02% |
| 0 | 366 | 692 | 1093 | 1181 |
| 3 h | 368 | 696 | 1091 | 1137 |
| 24 h | 363 | 691 | 1094 | 747 |

From Tables 15 and 16 it can be observed that spray-dried soluble citrus fiber provided both the deionized water and the citrate buffer solution with an excellent turbidity that was at least stable for the time measured (24 hours). It can further be observed that by the addition of spray-dried soluble citrus fibers at an amount of 3 g/100 ml, a turbidity comparable to the titanium dioxide solution could be achieved that was, however, stable over 24 hours as opposed to the titanium dioxide solution.

### Example 6

Soluble citrus fibers were prepared as described in Example 1. The soluble citrus fibers were then dispersed in deionized water at various concentrations (1 g/100 mL, 2 g/100 mL, 3 g/100 mL, 4 g/100 mL, and 5 g/100 mL) and the viscosity of the samples were determined at different shear rates at a temperature of 25° C. Further, the viscosity of two commercial beer samples (Carlsberg Beer and Kronenbourg Fruity Beer) has been determined. The viscosities have been determined with a Anton Paar MCR 502 rheometer.

The results of the viscosity measurements are shown in the FIGURE. It can be observed that the samples with 1 g/100 mL, 2 g/100 mL, and 3 g/100 mL of soluble citrus fibers showed a low viscosity comparable to commercial beer samples. By contrast, higher amounts of citrus fibers (4 g/100 mL and 5 g/100 mL) showed a much higher viscosity.

This demonstrates that soluble citrus fiber concentrations up to 3 g/100 ml are particularly suitable for thin liquid/thin beverage applications.

1. A beverage additive comprising
a clouding agent comprising a soluble citrus fiber, and
optionally, one or more beverage ingredients.

2. The beverage additive of claim 1, wherein the clouding agent does not comprise an insoluble citrus fiber.

3. The beverage additive of claim 1, wherein the soluble citrus fiber has a solubility up to 8 g/100 ml, based on its solubility in water at 20° C.

4. The beverage additive according to claim 1, wherein the soluble citrus fiber is obtained from orange, lemon, lime, or any mixture thereof.

5. The beverage additive according to claim 1, wherein the beverage additive is in powdered form or in the form of a liquid concentrate.

6. A beverage comprising the beverage additive according to claim 1, and a beverage base.

7. The beverage of claim 6, wherein the concentration of soluble citrus fiber in the beverage is from 0.01 to 5 g/100 ml.

8. The beverage of claim 6, wherein the soluble citrus fiber in the beverage has a colloidal particle size of from 0.1 to 10 μm.

9. The beverage of claim 6, wherein the beverage has a turbidity of from 8 to 500 NTU.

10. The beverage of claim 6, wherein the beverage is an alcoholic beverage.

11. The beverage of claim 6, wherein the beverage is an acidic beverage.

12. (canceled)

13. A method of increasing the turbidity of a beverage comprising the step of adding a soluble citrus fiber to a beverage.

14. A method for preparing soluble citrus fibers comprising the steps of:
a) Dispersing a mixture of soluble and insoluble citrus fibers in water;
b) Subjecting the dispersion obtained in step a) to a centrifugation step, wherein a relative centrifugal force (RCF) of at least 1500×g is applied;
c) Collecting the supernatant comprising soluble citrus fibers;
d) Optionally, subjecting the supernatant to a concentration step and/or to a drying step.

15. The method according to claim 14, wherein the drying step is performed by means of freeze-drying or spray-drying.

16. The beverage of claim 7, wherein the concentration of soluble citrus fiber in the beverage is from 0.01 to 2 g/100 ml.

17. The beverage of claim 8, wherein the soluble citrus fiber in the beverage has a colloidal particle size of from 1 to 3 μm.

18. The beverage of claim 9, wherein the beverage has a turbidity of from 120 to 250 NTU.

19. The beverage of claim 10, wherein the beverage is a beer.

20. The beverage of claim 11, wherein the beverage has a pH of from 2 to 6.

21. The beverage of claim 20, wherein the beverage has a pH of from 3 to 4.
